(19) United States
(12) Patent Application Publication
(10) Pub. No.: US 2026/0190153 A1
(43) Pub. Date: Jul. 2, 2026

(54) RANDOM ACCESS METHOD AND APPARATUS

(71) Applicant: Beijing Xiaomi Mobile Software Co., Ltd., Beijing (CN)

(72) Inventor: Xuemei QIAO, Beijing (CN)

(73) Assignee: Beijing Xiaomi Mobile Software Co., Ltd., Beijing (CN)

(21) Appl. No.: 19/127,583

(22) PCT Filed: Nov. 6, 2022
(86) PCT No.: PCT/CN2022/130175

§ 371 Date: May 6, 2025

(51) Int. Cl. H04W 74/0833; H04W 72/232

(52) U.S. Cl. CPC H04W 74/0833; H04W 72/232

(57) ABSTRACT

Disclosed in the embodiments of the present application are a random access method and apparatus. By means of receiving downlink control information (DCI) sent by a network device, and determining, according to the DCI, the number of transmissions of a physical random access channel (PRACH), a terminal can determine a relatively rational number of transmissions of the PRACH in an attempt of random access, so as to perform rational coverage enhancement on the PRACH, thereby effectively ensuring the fairness of an access opportunity, reducing the energy consumption of the terminal, and improving the communication efficiency of a system.

### CROSS-REFERENCE TO RELATED APPLICATION

The application is a U.S. National Stage of International Application No. PCT/CN2022/130175 filed on Nov. 6, 2022, the entire content of which is incorporated herein by reference.

### TECHNICAL FIELD

The present application relates to the technical field of communication, and in particular, to a random access method and apparatus.

### BACKGROUND

In the four-step random access process of the 5G new radio (NR) system, two types of random access, namely, the contention-based random access (CBRA) and the non-contention-based random access or contention-free random access (CFRA), are supported.

### SUMMARY

An embodiment of a first aspect of the present application provides a random access method, which is performed by a terminal device and includes:
receiving downlink control information (DCI) sent by a network device; and
determining the number of transmissions of a physical random access channel (PRACH) according to the DCI.

An embodiment of a second aspect of the present application provides a random access method, which is performed by a network device and includes:
sending downlink control information (DCI) to a terminal device; where the DCI is used to indicate the number of transmissions of a physical random access channel (PRACH) of the terminal device.

An embodiment of a third aspect of the present application provides a random access apparatus, which is applied to a terminal device and includes:
a transceiver unit, configured to receive downlink control information (DCI) sent by a network device; and
a processing unit, configured to determine the number of transmissions of a physical random access channel (PRACH) according to the DCI.

An embodiment of a fourth aspect of the present application provides a random access apparatus, which is applied to a network device, and includes:
a transceiver unit, configured to send downlink control information (DCI) to a terminal device; where the DCI is used to indicate the number of transmissions of a physical random access channel (PRACH) of the terminal device.

An embodiment of a fifth aspect of the present application provides a communication apparatus, which includes a processor and a memory, where the memory stores a computer program, and the processor executes the computer program stored in the memory to cause the apparatus to perform the above random access method described in the embodiment of the first aspect.

An embodiment of a sixth aspect of the present application provides a communication apparatus, which includes a processor and a memory, where the memory stores a computer program, and the processor executes the computer program stored in the memory to cause the apparatus to perform the above random access method described in the embodiment of the second aspect.

An embodiment of a seventh aspect of the present application provides a communication apparatus, which includes a processor and an interface circuit, where the interface circuit is configured to receive code instructions and transmit them to the processor, and the processor is configured to run the code instructions to cause the apparatus to perform the above random access method described in the embodiment of the first aspect.

An embodiment of an eighth aspect of the present application provides a communication apparatus, which includes a processor and an interface circuit, where the interface circuit is configured to receive code instructions and transmit them to the processor, and the processor is configured to run the code instructions to cause the apparatus to perform the above random access method described in the embodiment of the second aspect.

An embodiment of a ninth aspect of the present application provides a computer-readable storage medium for storing instructions, which, when being executed, implement the random access method described in the embodiment of the first aspect.

An embodiment of a tenth aspect of the present application provides a computer-readable storage medium for storing instructions, which, when being executed, implement the random access method described in the embodiment of the second aspect.

An embodiment of an eleventh aspect of the present application provides a computer program, which, when running on a computer, causes the computer to perform the random access method described in the embodiment of the first aspect.

An embodiment of a twelfth aspect of the present application provides a computer program, which, when running on a computer, causes the computer to perform the random access method described in the embodiment of the second aspect.

Additional aspects and advantages of the present application will be given in part in the description below, and in part will become apparent from the description below, or will be learned through the practice of the present application.

### BRIEF DESCRIPTION OF THE DRAWINGS

In order to illustrate the technical solutions of the embodiments of the present application or the background in a clearer manner, the drawings that need to be used in the embodiments of the present application or the background will be described in the following.

FIG. 1 is a schematic diagram of the architecture of a communication system provided by an embodiment of the present application;

FIG. 2 is a schematic flow chart of a random access method provided by an embodiment of the present application;

FIG. 3 is a schematic flow chart of a random access method provided by an embodiment of the present application;

FIG. 4 is a schematic flow chart of a random access method provided by an embodiment of the present application;

FIG. 5 is a schematic flow chart of a random access method provided by an embodiment of the present application;

FIG. 6 is a schematic flow chart of a random access method provided by an embodiment of the present application;

FIG. 7 is a schematic flow chart of a random access method provided by an embodiment of the present application;

FIG. 8 is a schematic structural diagram of a random access apparatus provided by an embodiment of the present application;

FIG. 9 is a schematic structural diagram of a random access apparatus provided by an embodiment of the present application;

FIG. 10 is a schematic structural diagram of another random access apparatus provided by an embodiment of the present application; and

FIG. 11 is a schematic structural diagram of a chip provided by an embodiment of the present application.

### DETAILED DESCRIPTION

Exemplary embodiments will be described in detail herein, examples of which are illustrated in the accompanying drawings. When the following description refers to the accompanying drawings, the same numbers in different drawings represent the same or similar elements unless otherwise indicated. The implementations set forth in the following description of illustrative embodiments do not represent all implementations consistent with embodiments of the present application. Instead, they are merely examples of apparatuses and methods consistent with some aspects related to embodiments of the present application as recited in the appended claims.

Terms used herein in embodiments of the present application are only for the purpose of describing specific embodiments, but should not be construed to limit the embodiments of the present application. As used in the embodiments of the present application and the appended claims, “a/an”, “said” and “the” in singular forms are intended to include plural forms, unless clearly indicated in the context otherwise. It should also be understood that, the term “and/or” used herein represents and contains any or all possible combinations of one or more associated listed items.

It should be understood that although the terms first, second, third, etc. may be used to describe various information in the embodiments of the present application, and such information should not be limited to these terms. These terms are only used to distinguish the same type of information from each other. For example, without departing from the scope of the embodiments of the present application, the first information may also be referred to as the second information, and similarly, the second information may also be referred to as the first information. Depending on the context, the word “if” and “in case” as used herein may be interpreted as “when . . . ” or “upon . . . ” or “in response to determination”.

The embodiments of the present application are described in detail below, and examples of the embodiments are shown in the accompanying drawings, in which the same or similar reference numerals throughout represent the same or similar elements. The embodiments described below with reference to the accompanying drawings are exemplary and are intended to be used to explain the present application, and should not be construed as limiting the present application.

In order to better understand the random access method disclosed in the embodiments of the present application, the communication system to which the embodiments of the present application are applicable is first described below.

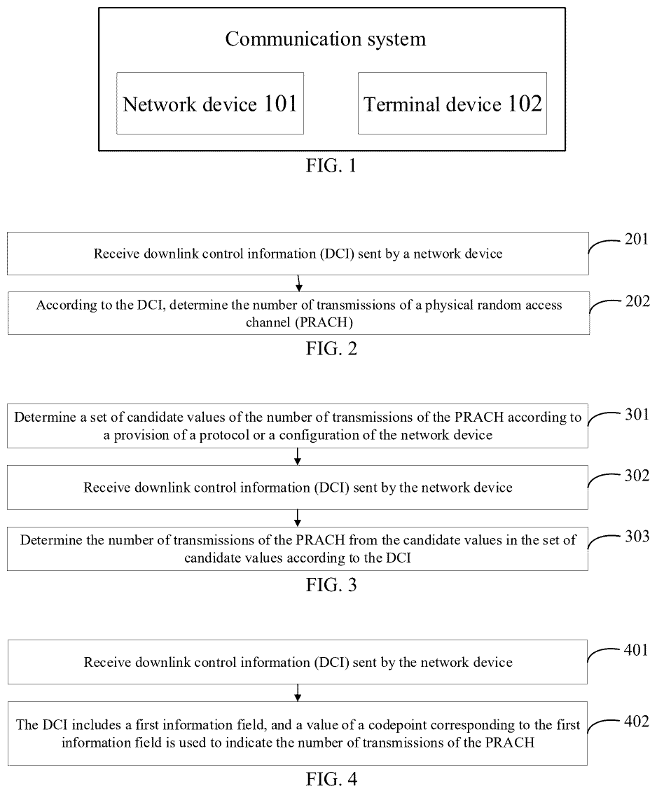

Reference is made to FIG. 1, which is a schematic diagram of the architecture of a communication system provided by an embodiment of the present application. The communication system may include, but is not limited to, a first network device, a second network device, and a terminal device. The number and form of devices shown in FIG. 1 are only for illustration purposes and do not constitute a limitation to the embodiments of the present application. In practical applications, it may include two or more network devices and two or more terminal devices. The communication system shown in FIG. 1 takes the case where a network device 101 and a terminal device 102 are included as an example.

It should be noted that the technical solutions of the embodiments of the present application can be applied to various communication systems, such as Long Term Evolution (LTE) system, the fifth-generation mobile communication system, 5G new air interface system, or other future new mobile communication systems, etc.

The network device 101 in the embodiments of the present application is an entity on the network side for transmitting or receiving signals. For example, the network device 101 may be an evolved NodeB (eNB), a transmission reception point (TRP), a next generation NodeB (gNB) in the NR system, a base station in other future mobile communication systems or an access point in a wireless fidelity (WiFi) system, etc. In the embodiments of the present application, a specific technology and a specific device form that are adopted by the network device are not limited. The network device provided in the embodiments of the present application may be composed of a central unit (CU) and a distributed unit (DU), and the CU may also be referred to as a control unit. The protocol layer of the network side device, such as a base station, can be split by adopting a CU-DU structure, parts of functions of the protocol layer are centrally controlled by the CU, and parts or all of the remaining functions of the protocol layer are distributed in the DU, and the DU is centrally controlled by the CU.

The terminal device 102 in the embodiment of the present application is an entity on the user side for receiving or transmitting signals, such as a mobile phone. The terminal device may also be referred to as a terminal, user equipment (UE), a mobile station (MS), a mobile terminal (MT), etc. The terminal device may be a car with a communication function, a smart car, a mobile phone, a wearable device, a tablet computer (Pad), a computer with a radio transceiver function, a virtual reality (VR) terminal device, an augmented reality (AR) terminal device, a radio terminal device in industrial control, a radio terminal in self-driving, a radio terminal device in remote medical surgery, a radio terminal in a smart grid, a radio terminal device in transportation safety, a radio terminal device in a smart city, a radio terminal device in a smart home, etc. In the embodiments of the present application, a specific technology and a specific device form that are adopted by the terminal device are not limited.

In the four-step random access process of the 5G new radio (NR) system, two types of random access, namely, the contention-based random access (CBRA) and the non-contention-based random access or contention-free random access (CFRA), are supported.

In the contention-based four-step random access process, the terminal device 102 may send a first random access message (message 1, Msg 1) to the network device 101. After receiving the Msg 1, the network device 101 may send a second random access message (message 2, Msg2) to the terminal device 102. After receiving the Msg 2, the terminal device 102 may send a third random access message (message 3, Msg 3) to the network device 101. After receiving the Msg 3, the network device 101 may send a fourth random access message (message 4, Msg4) to the terminal device 102.

In 3GPP R18, for the physical random access channel (PRACH) coverage enhancement, it is proposed that a plurality of transmissions may be performed in the time domain, that is, the PRACH is repeatedly transmitted (repetition). For a terminal device 102 that supports PRACH repetition, how to determine the number of transmissions of the PRACH is an issue that needs to be considered.

In 3GPP R18, for the physical random access channel (PRACH) coverage enhancement, it is proposed that a plurality of transmissions may be performed in the time domain, that is, the PRACH is repeatedly transmitted (repetition). For a terminal device 102 that supports PRACH repetition, how to configure the resources used to initiate the random access is an issue that needs to be considered. One possible direction is that the terminal device 102 performs repeated transmissions on multiple transmission occasions (that is, random access occasions, ROs) using the same uplink transmission beam (UL TX beam). The multiple transmission occasions correspond to multiple transmission time slots, which may be continuous or discrete, and are not limited herein.

It is understandable that the communication system described in the embodiments of the present application is intended to illustrate the technical solutions of the embodiments of the present application more clearly, and does not constitute a limitation to the technical solutions provided by the embodiments of the present application. Those of ordinary skill in the art know that with the evolution of the system architecture and the emergence of new service scenarios, the technical solutions provided by the embodiments of the present application are also applicable to similar technical problems.

The random access method and apparatus provided by the present application are described in detail below with reference to the accompanying drawings.

Reference is made to FIG. 2, which is a schematic flow chart of a random access method provided in an embodiment of the present application. It should be noted that the random access method in the embodiment of the present application is performed by a terminal device, and the terminal device supports retransmission of the physical random access channel (PRACH). The method may be performed independently or in combination with any other embodiment of the present application. As shown in FIG. 2, the method may include the following steps.

In step 201, downlink control information (DCI) sent by a network device is received.

In the embodiment of the present application, the terminal device may receive downlink control information (DCI) sent by a network device determine the number of transmissions of the physical random access channel (PRACH) according to the DCI.

In step 202, the number of transmissions of the physical random access channel (PRACH) is determined according to the DCI.

In the embodiment of the present application, the terminal device may determine the number of transmissions of the PRACH according to the received DCI.

In the embodiment of the present application, the DCI is used to indicate the number of transmissions of the PRACH, or the DCI is used to instruct the terminal device to determine the number of transmissions of the PRACH based on a comparison between a measured value of a reference signal and at least one preset threshold. In a possible implementation, the DCI may explicitly or implicitly indicate the number of transmissions of the PRACH.

Implicit indication means that the number of PRACH transmissions is indicated through the format or other parameters of the DCI, where different formats or parameters of the DCI may correspond to different numbers of transmissions of the PRACH.

Explicit indication means that the DCI has a field for indication. For example, in the embodiments of the present application, the DCI includes a first information field, the first information field is used to indicate the number of transmissions of the PRACH, and/or, the first information field is used to indicate that the terminal device determines the number of transmissions of the PRACH according to a comparison between a measured value of a reference signal and at least one preset threshold. As a possible implementation, the terminal device may determine the number of transmissions of the PRACH according to the indication of the first information field.

As another possible implementation, the terminal device may determine the number of transmissions of the PRACH by comparing the measured value of the reference signal with at least one preset threshold according to the received DCI.

As another possible implementation, the terminal device may compare the number of transmissions determined according to the indication of the first information field with the number of transmissions determined by comparing the measured value of the reference signal with at least one preset threshold, and determine the number of transmissions of the PRACH according to the comparison result of the transmission numbers determined by the two manners.

Optionally, the at least one preset threshold, and the number of transmissions of the PRACH corresponding to each preset threshold, may be determined according to a provision of a protocol, or may be determined according to a configuration or indication of a network device.

In the embodiment of the present application, the first information field may occupy the reserved bits in the DCI, or may multiplex the existing information fields in the DCI.

In some implementations, the terminal device may determine a set of candidate values for the number of transmissions according to a provision of the protocol or the configuration of the network device, and the first information field is used to indicate an index of a candidate value in the set of candidate values.

Optionally, the network device may configure the set of candidate values through Radio Resource Control (RRC) signaling.

Optionally, the set of candidate values may include at least one candidate value of the number of PRACH transmissions.

Optionally, the bit width of the first information field, that is, the number of bits occupied by the first information field, is determined according to the number of candidate values in the set of candidate values.

Optionally, the set of candidate values may include a first value. If the first information field is used to indicate an index corresponding to the first value, the first information field is used to instruct the terminal device to determine the number of transmissions according to the comparison between the measured value of the reference signal and at least one preset threshold.

Optionally, the first value is a null value, such as null or none.

Optionally, if each of at least one bit in the first information field is 0, or the first information field is a multiplexed information field and the value of the first information field remains an original value of the multiplexed information field, the first information field is used to indicate that the PRACH is transmitted once.

Optionally, if each of at least one bit in the first information field is 0, or the first information field is a multiplexed information field and the value of the first information field remains an original value of the multiplexed information field, the first information field is used to indicate a candidate value corresponding to the smallest index in the set of candidate values.

In some implementations, if each of at least one bit in the first information field is 0, or the first information field is a multiplexed information field and the value of the first information field remains an original value of the multiplexed information field, the first information field is used to instruct the terminal device to determine the number of transmissions based on the comparison between the measured value of the reference signal and the at least one preset threshold.

In some implementations, the value of a codepoint of the first information field is used to determine the number of transmissions of the PRACH.

Optionally, the maximum value of the value of the codepoint corresponding to the first information field is greater than or equal to the maximum number of PRACH transmissions supported by the terminal device.

In some implementations, the terminal device may determine the number of transmissions of the PRACH by comparing the number of transmissions determined according to the indication of the first information field with the number of transmissions determined by comparing the measured value of the reference signal with the at least one preset threshold.

Specifically, the terminal device may determine a first number of transmissions indicated by the first information field of the DCI, and the terminal device may also determine a second number of transmissions determined according to comparison between the measured value of the reference signal and the at least one preset threshold. The terminal device may compare the first number of transmissions with the second number of transmissions, and determine that the number of transmissions of the PRACH is the larger value between the first number of transmissions and the second number of transmissions.

In some implementations, the terminal device determines the number of transmissions of the PRACH according to the first information field, and the random access initiated based on the number of transmissions fails, then the terminal device needs to initiate PRACH retransmission. The terminal device may select at least one of the following manners.

The terminal may choose to determine the number of retransmissions of the PRACH according to the comparison between the measured value of the reference signal and the at least one preset threshold.

The terminal device may also choose to perform PRACH retransmission still based on the number of transmissions indicated by the first information field, that is, determine the number of retransmissions of the PRACH to be the number of transmissions indicated by the first information field.

The terminal device may also choose to wait for receiving first indication information sent by the network device before performing PRACH retransmission, where the first indication information is used to indicate the number of retransmissions of the PRACH, or the first indication information is used to instruct the terminal device to determine the number of retransmissions of the PRACH by itself (for example, determined based on the comparison between the measured value of the reference signal and the at least one preset threshold, or determined based on the number of transmissions indicated by the first information field, etc.).

Optionally, the failure of the random access initiated refers to a failure to receive a second random access message (Msg2).

In various embodiments of the present application, the terminal device determining the number of transmissions of the PRACH by comparing the measured value of the reference signal with at least one preset threshold may specifically include: measuring the reference signal receiving power (RSRP) of the reference signal sent by the network device, comparing the RSRP with the at least one preset threshold, and determining the number of transmissions of the PRACH.

Optionally, the reference signal may be a secondary synchronization signal (SSS), a synchronization signal and physical broadcast channel block (Synchronization Signal and PBCH Block, SSB), or other reference signals, etc., which is not limited in the present application.

In various embodiments of the present application, the DCI is further used to instruct the terminal device to initiate a contention-based random access (CBRA), or the DCI is used to instruct the terminal device to initiate a non-contention-based random access (CFRA).

In various embodiments of the present application, the terminal device may also receive an RRC reconfiguration signaling sent by the network device to reconfigure the number of PRACH transmissions of the terminal device and/or the at least one preset threshold. If the terminal device does not receive the reconfigured number of PRACH transmissions and/or the at least one preset threshold in the RRC reconfiguration signaling, the terminal device can configure the number of PRACH transmissions and/or the at least one preset threshold according to the configuration parameters of the system information block, such as the RACHConfigCommon in SIB 1.

In summary, by receiving the downlink control information (DCI) sent by the network device, the number of transmissions of the physical random access channel (PRACH) is determined according to the DCI, so that the terminal device can determine a more reasonable number of transmissions of the physical random access channel (PRACH) in one random access attempt, and reasonably enhance the coverage of PRACH, thereby effectively ensuring the fairness of access opportunities, saving power consumption of the terminal device, and improving the communication efficiency of the system.

Reference is made to FIG. 3, which is a schematic flow chart of a random access method provided in an embodiment of the present application. It should be noted that the random access method in the embodiment of the present application is performed by a terminal device, and the terminal device supports physical random access channel (PRACH) retransmission. The method may be performed independently or in combination with any other embodiment of the present application. As shown in FIG. 3, the method may include the following steps.

In step 301, a set of candidate values of the number of transmissions of the PRACH is determined according to a communication protocol or pre-configuration information or configuration of the network device.

In the embodiment of the present application, the terminal device may determine a set of candidate values of the number of PRACH transmissions according to the provision of the protocol or the configuration of the network device.

Optionally, the set of candidate values may be directly defined in the protocol.

Optionally, the network device may configure the set of candidate values through an RRC signaling.

Optionally, the set of candidate values may include at least one candidate value of the number of transmissions of the PRACH.

As an example, the set of candidate values is {2, 4, 8} or the set of candidate values is {2, 4}, etc. The set of candidate values may further include a single transmission of PRACH, that is, the set of candidate values includes the number 1. For example, the set of candidate values is {1, 2, 4, 8} or the set of candidate values is {1, 2, 4}, etc.

As a possible implementation, all possible candidate values of the number of PRACH transmissions may be directly defined in the protocol, and the network device may configure all possible candidate values defined in the protocol, or a subset of all possible candidate values, through RRC signaling.

In step 302, downlink control information (DCI) sent by a network device is received.

In the embodiment of the present application, the terminal device may receive the DCI sent by a network device, and the terminal device may determine the number of transmissions of the physical random access channel (PRACH) according to the DCI.

In step 303, the number of transmissions of the PRACH is determined from the candidate values in the set of candidate values according to the DCI.

As described above, the number of transmissions of the PRACH may be indicated implicitly or explicitly through the DCI. Implicit indication means indicating the number of transmissions of the PRACH through the correspondence between the formats or other parameters of the DCI and the candidate values in the set of candidate values, where different formats or parameters of the DCI may correspond to different numbers of transmissions of the PRACH.

Explicit indication means that the DCI has a field for indication. For example, the DCI includes a first information field, and the first information field is used to indicate the index corresponding to the candidate value in the set of candidate values.

In the embodiment of the present application, the terminal device may determine the number of transmissions of the PRACH according to the indication of the first information field.

In the embodiment of the present application, the first information field may be used to indicate the index corresponding to the candidate value in the set of candidate values.

For example, the set of candidate values is {2, 4, 8}, and the first information field is 01, which is used to indicate index #1 in the set of candidate values, that is, the first information field is used to indicate that the number of transmissions of the PRACH is candidate value 2 corresponding to index #1, that is, the number of transmissions is 2. As an example, if the set of candidate values includes a single transmission, such as the set of candidate values is {1, 2, 4, 8}, the first information field being 00 may be used to indicate the index corresponding to the single transmission in the set of candidate values.

In some implementations, the bit width of the first information field, that is, the number of bits occupied by the first information field, may be determined according to the number of candidate values in the set of candidate values.

For example, the number of candidate values in the set of candidate values is M, and the bit width of the first information field may be ceiling(log 2(M+1)) or ceiling(log 2(M)), where ceiling(⋅) represents rounding up.

In some implementations, the set of candidate values may include a first value. If the first information field is used to indicate an index corresponding to the first value, the first information field is used to indicate that the terminal device determines the number of transmissions according to a comparison between a measured value of a reference signal and at least one preset threshold.

Optionally, the first value is a null value, such as none or null, etc. For example, the index value set is {1, 2, 4, 8, none} or the index value set is {2, 4, 8, none}, etc.

In some implementations, if each of at least one bit in the first information field is 0, or the first information field is a multiplexed information field and the value of the first information field remains an original value of the multiplexed information field, the first information field is used to indicate that the PRACH is transmitted once.

In some implementations, if at least one bit in the first information field is all 0, or the first information field is a multiplexed information field and the value of the first information field remains an original value of the multiplexed information field, the first information field is used to indicate a candidate value corresponding to the smallest index in the set of candidate values.

In some implementations, the terminal device determines the number of transmissions of the PRACH according to the first information field, and the random access initiated based on the number of transmissions fails, then the terminal device needs to initiate PRACH retransmission. The terminal device may select at least one of the following manners.

The terminal may choose to determine the number of retransmissions of the PRACH according to the comparison between the measured value of the reference signal and the at least one preset threshold.

The terminal device may also choose to perform PRACH retransmission still based on the number of transmissions indicated by the first information field, that is, determine the number of retransmissions of the PRACH to be the number of transmissions indicated by the first information field.

The terminal device may also choose to wait for receiving first indication information sent by the network device before performing PRACH retransmission, where the first indication information is used to indicate the number of retransmissions of the PRACH, or the first indication information is used to instruct the terminal device to determine the number of retransmissions of the PRACH by itself (for example, determined based on the comparison between the measured value of the reference signal and the at least one preset threshold, or determined based on the number of transmissions indicated by the first information field, etc.).

Optionally, the failure of the random access initiated refers to a failure to receive a second random access message (Msg2).

In various embodiments of the present application, the terminal device determining the number of transmissions of the PRACH by comparing the measured value of the reference signal with at least one preset threshold may specifically include: measuring the reference signal receiving power (RSRP) of the reference signal sent by the network device, comparing the RSRP with the at least one preset threshold, and determining the number of transmissions of the PRACH.

Optionally, the reference signal may be a secondary synchronization signal (SSS), a synchronization signal and physical broadcast channel block (SSB), or other reference signals, etc., which is not limited in the present application.

In various embodiments of the present application, the DCI is further used to instruct the terminal device to initiate a contention-based random access (CBRA), or the DCI is used to instruct the terminal device to initiate a non-contention-based random access (CFRA).

In various embodiments of the present application, the terminal device may also receive an RRC reconfiguration signaling sent by the network device to reconfigure the number of PRACH transmissions of the terminal device and/or the at least one preset threshold. If the terminal device does not receive the reconfigured number of PRACH transmissions and/or the at least one preset threshold in the RRC reconfiguration signaling, the terminal device may configure the number of PRACH transmissions and/or the at least one preset threshold according to the configuration parameters of the system information block, such as the RACHConfigCommon in SIB 1.

In summary, a set of candidate values of the number of transmissions of the PRACH is determined according to the provision of the protocol or the configuration of the network device, and the downlink control information (DCI) sent by the network device is received, where the DCI includes a first information field, and the first information field is used to indicate the index corresponding to the candidate value in the set of candidate values, so that the terminal device can determine a more reasonable number of transmissions of the physical random access channel (PRACH) in one random access attempt, and reasonably enhance the coverage of PRACH, thereby effectively ensuring the fairness of access opportunities, saving power consumption of the terminal device, and improving the communication efficiency of the system.

Reference is made to FIG. 4, which is a schematic flow chart of a random access method provided in an embodiment of the present application. It should be noted that the random access method in the embodiment of the present application is performed by a terminal device, and the terminal device supports physical random access channel (PRACH) retransmission. The method may be performed independently or in combination with any other embodiment of the present application. As shown in FIG. 4, the method may include the following steps.

In step 401, downlink control information (DCI) sent by a network device is received.

In the embodiment of the present application, the terminal device may receive the DCI sent by a network device, and the terminal device may determine the number of transmissions of the physical random access channel (PRACH) according to the DCI.

In step 402, the DCI includes a first information field, and a value of a codepoint corresponding to the first information field is used to indicate the number of transmissions of the PRACH.

In the embodiment of the present application, the value of the codepoint of the first information field is used to determine the number of transmissions of the PRACH.

In the embodiment of the present application, the first information field may include at least one codepoint. The at least one codepoint included in the first information field means that, for example, if the first information field has 3 bits, then the first information field includes 8 codepoints, which are 000, 001, 010, 011, 100, 101, 110, 111. The value of the codepoint corresponding to the first information field means that, for example, if the first information field is 001, then the value of the codepoint corresponding to the first information field is 1, and if the first information field is 100, then the value of the codepoint corresponding to the first information field is 4.

As an example, the value of the codepoint of the first information field being used to indicate the number of transmissions of the PRACH means that, for example, if the first information field is 100, the value of the codepoint corresponding to the first information field is 4, which indicates that the number of transmissions of the PRACH is 4.

It can be understood that in the embodiment of the present application, the maximum value of the value of the codepoint corresponding to the first information field should be greater than or equal to the maximum number of transmissions of the PRACH supported by the terminal device, so that the value of the codepoint corresponding to the first information field is able to indicate all possible numbers of PRACH transmissions supported by the terminal device.

In some implementations, if at least one bit in the first information field is all 0, or the first information field is a multiplexed information field and the value of the first information field remains an original value of the multiplexed information field, the first information field is used to instruct the terminal device to determine the number of transmissions according to a comparison between a measured value of a reference signal and at least one preset threshold.

In some implementations, the terminal device determines the number of transmissions of the PRACH according to the first information field, and the random access initiated based on the number of transmissions fails, then the terminal device needs to initiate PRACH retransmission. The terminal device may select at least one of the following manners.

The terminal may choose to determine the number of retransmissions of the PRACH according to the comparison between the measured value of the reference signal and the at least one preset threshold.

The terminal device may also choose to perform PRACH retransmission still based on the number of transmissions indicated by the first information field, that is, determine the number of retransmissions of the PRACH to be the number of transmissions indicated by the first information field.

The terminal device may also choose to wait for receiving first indication information sent by the network device before performing PRACH retransmission, where the first indication information is used to indicate the number of retransmissions of the PRACH, or the first indication information is used to instruct the terminal device to determine the number of retransmissions of the PRACH by itself (for example, determined based on the comparison between the measured value of the reference signal and the at least one preset threshold, or determined based on the number of transmissions indicated by the first information field, etc.).

Optionally, the failure of the random access initiated refers to a failure to receive a second random access message (Msg2).

In various embodiments of the present application, the terminal device determining the number of transmissions of the PRACH by comparing the measured value of the reference signal with at least one preset threshold may specifically include: measuring the reference signal receiving power (RSRP) of the reference signal sent by the network device, comparing the RSRP with the at least one preset threshold, and determining the number of transmissions of the PRACH.

Optionally, the reference signal may be a secondary synchronization signal (SSS), a synchronization signal and physical broadcast channel block (SSB), or other reference signals, etc., which is not limited in the present application.

In various embodiments of the present application, the DCI is further used to instruct the terminal device to initiate a contention-based random access (CBRA), or the DCI is used to instruct the terminal device to initiate a non-contention-based random access (CFRA).

In summary, the downlink control information (DCI) sent by the network device is received, where the DCI includes a first information field, and the value of the codepoint corresponding to the first information field is used to indicate the number of transmissions of the PRACH, so that the terminal device can determine a more reasonable number of transmissions of the physical random access channel (PRACH) in one random access attempt, and reasonably enhance the coverage of PRACH, thereby effectively ensuring the fairness of access opportunities, saving power consumption of the terminal device, and improving the communication efficiency of the system.

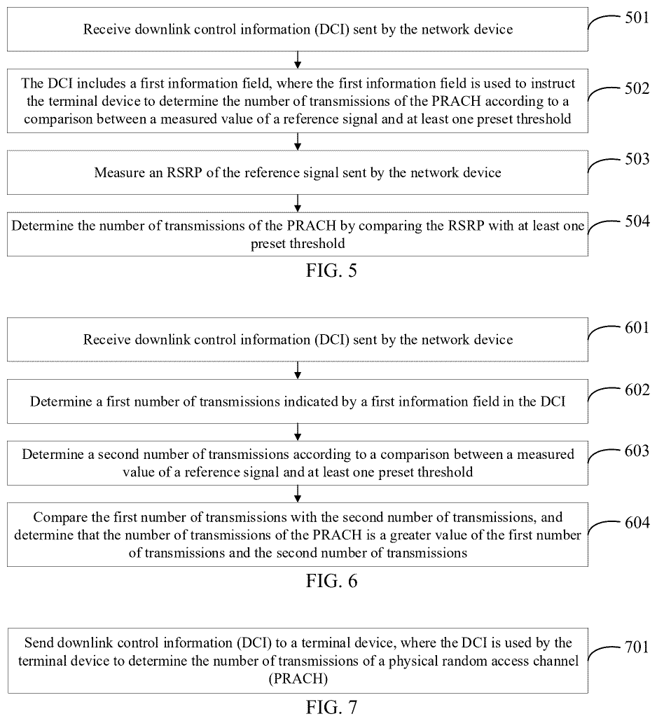

Reference is made to FIG. 5, which is a schematic flow chart of a random access method provided in an embodiment of the present application. It should be noted that the random access method in the embodiment of the present application is performed by a terminal device, and the terminal device supports physical random access channel (PRACH) retransmission. The method may be performed independently or in combination with any other embodiment of the present application. As shown in FIG. 5, the method may include the following steps.

In step 501, downlink control information (DCI) sent by a network device is received.

In the embodiment of the present application, the terminal device may receive the DCI sent by a network device, and the terminal device may determine the number of transmissions of the physical random access channel (PRACH) according to the DCI.

In step 502, the DCI includes a first information field, where the first information field is used to instruct the terminal device to determine the number of transmissions of the PRACH according to a comparison between a measured value of a reference signal and at least one preset threshold.

In some implementations, if each of at least one bit in the first information field is 0, or the first information field is a multiplexed information field and the value of the first information field remains an original value of the multiplexed information field, the first information field is used to instruct the terminal device to determine the number of transmissions according to the comparison between the measured value of the reference signal and the at least one preset threshold.

In some implementations, the terminal device is capable of determining a set of candidate values of the number of PRACH transmissions, and the set of candidate values includes a first value. The first information field is used to indicate an index corresponding to the first value, and the first information field is used to instruct the terminal device to determine the number of transmissions based on the comparison between the measured value of the reference signal and the at least one preset threshold.

Optionally, the first value is a null value, such as null or none.

In step 503, an RSRP of the reference signal sent by the network device is measured.

In the embodiment of the present application, the terminal device is capable of measuring the RSRP of the reference signal sent by the network device.

Optionally, the reference signal may be a secondary synchronization signal (SSS), a synchronization signal and physical broadcast channel block (SSB), or other reference signals, etc., which is not limited in the present application.

In step 504, the RSRP is compared with at least one preset threshold to determine the number of transmissions of the PRACH.

In the embodiment of the present application, the terminal device can determine the coverage of the uplink channel of the terminal device according to the comparison between the measured RSRP and the at least one preset threshold, and determine a corresponding number of PRACH transmissions.

In the embodiment of the present application, for the at least one preset threshold, each preset threshold has a corresponding number of transmissions of the PRACH.

In some implementations, the at least one preset threshold, and the number of transmissions of the PRACH corresponding to each preset threshold, are determined according to a provision of a protocol or a configuration/instruction of the network device.

As an example, as shown in the following table, the terminal device may determine four preset thresholds and the corresponding number of transmissions according to the provision of the protocol or the configuration/instruction of the network device. It can be understood that the at least one preset threshold and the corresponding number of transmissions shown in the table are only illustrated as an example, and other numbers of preset thresholds and the number of transmissions corresponding to each preset threshold may also be set, which is not limited herein.

| Threshold | Number of repeated transmissions |
|---|---|
| Threshold 1 | M |
| Threshold 2 | N |
| Threshold 3 | P |
| Threshold 4 | Q |

Threshold 1>threshold 2>threshold 3>threshold 4, M<N<P<Q, and M, N, P, and Q are all natural numbers.

For at least one preset threshold and the corresponding number of repeated transmissions as shown in this example, if the RSRP measured by the terminal device is greater than threshold 1, no repeated transmission is performed, that is, a single PRACH transmission is performed; if the RSRP is less than threshold 1 but greater than threshold 2, M PRACH repeated transmissions are performed; if the RSRP is less than threshold 2 but greater than threshold 3, N repeated transmissions are performed; if the RSRP is less than threshold 3 but greater than threshold 4, P PRACH repeated transmissions are performed; and if the RSRP is less than threshold 4, Q PRACH repeated transmissions are performed.

In some implementations, the network device may configure each of the at least one preset thresholds, and the terminal device determines the at least one preset threshold by receiving the configuration of the network device. Alternatively, the indication of the network device is used to indicate each of the at least one preset thresholds, and the terminal device determines the at least one preset threshold by receiving the indication of the network device.

In some implementations, the network device may also configure only one of the at least one preset threshold, and the remaining preset thresholds are determined according to a certain calculation formula.

As an example, for example, the network device only configures threshold 1, threshold 2=threshold 1+Δ, threshold 3=threshold 1+2, etc. The specific value of Δ may be agreed by the protocol (e.g., the value of Δ is −3 dB) or indicated by the network device.

In addition, optionally, the number of the at least one preset threshold may be indicated by the network device or specified by the protocol, and may also be determined by other implicit manners, such as determined through the configuration of the number of PRACH transmissions.

In some implementations, the protocol may specify each of the at least one preset threshold, and the terminal device determines the at least one preset threshold according to the provisions of the protocol. The protocol may also specify only one of the at least one preset threshold, and the remaining preset thresholds are determined according to a certain calculation formula.

In some implementations, the network device may configure the number of PRACH transmissions corresponding to each preset threshold, and the terminal device determines the number of PRACH transmissions corresponding to each preset threshold by receiving the configuration of the network device. Alternatively, the indication of the network device is used to indicate the number of PRACH transmissions corresponding to each preset threshold, and the terminal device determines the number of PRACH transmissions corresponding to each preset threshold by receiving the indication of the network device.

In some implementations, the network device may also configure the number of PRACH transmissions corresponding to one preset threshold, and the numbers of PRACH transmissions corresponding to other preset thresholds are determined according to a certain calculation formula.

As an example, for example, the network device only configures the number of transmissions M, the number of transmissions N=M*k, P=M*2k, etc. The specific value of k may be agreed by the protocol (for example, the value of k is 2) or indicated by the network device.

In addition, optionally, the quantity of the numbers of PRACH transmissions may be indicated by a network device or specified by a protocol, and may also be determined through other implicit manners, such as the number of preset thresholds.

In some implementations, the protocol may specify the number of PRACH transmissions corresponding to each preset threshold, and the terminal device determines the number of PRACH transmissions corresponding to each preset threshold according to the provision of the protocol. The protocol may also only specify the number of PRACH transmissions corresponding to one preset threshold, and the number of PRACH transmissions corresponding to the remaining preset thresholds is determined according to a certain calculation formula.

In various embodiments of the present application, the DCI is further used to instruct the terminal device to initiate a contention-based random access (CBRA), or the DCI is used to instruct the terminal device to initiate a non-contention-based random access (CFRA).

In summary, the downlink control information (DCI) sent by the network device is received, where the DCI includes a first information field, and the first information field is used to instruct the terminal device to determine the number of transmissions of the PRACH based on the comparison between the measured value of the reference signal and at least one preset threshold; the RSRP of the reference signal sent by the network device is measured, and the RSRP is compared with at least one preset threshold; and the number of transmissions of the PRACH is determined. In this way, the terminal device can determine a more reasonable number of transmissions of the physical random access channel (PRACH) in one random access attempt, and reasonably enhance the coverage of PRACH, thereby effectively ensuring the fairness of access opportunities, saving power consumption of the terminal device, and improving the communication efficiency of the system.

Reference is made to FIG. 6, which is a schematic flow chart of a random access method provided in an embodiment of the present application. It should be noted that the random access method in the embodiment of the present application is performed by a terminal device, and the terminal device supports physical random access channel (PRACH) retransmission. The method may be performed independently or in combination with any other embodiment of the present application. As shown in FIG. 6, the method may include the following steps.

In step 601, downlink control information (DCI) sent by a network device is received.

In the embodiment of the present application, the terminal device may receive the DCI sent by a network device, and the terminal device may determine the number of transmissions of the physical random access channel (PRACH) according to the DCI.

In step 602, a first number of transmissions indicated by a first information field in the DCI is determined.

In the embodiment of the present application, the terminal device may determine the first number of transmissions indicated by the first information field in the DCI.

In the embodiment of the present application, the manner in which the first information field is used to indicate the first number of transmissions may be selected from any manner described in any of the aforementioned embodiments (such as indicating an index in a set of candidate values, etc.), which will not be repeated in the embodiment of the present application.

In step 603, a second number of transmissions is determined based on a comparison between a measured value of a reference signal and at least one preset threshold.

In the embodiment of the present application, the terminal device may determine a second number of transmissions by comparing the measured value of the reference signal with the at least one preset threshold.

In the embodiment of the present application, the manner in which the terminal device determines the second number of transmissions according to the comparison between the measured value of the reference signal and at least one preset threshold may be selected from any manner as described in any of the aforementioned embodiments, which will not be repeated in the embodiment of the present application.

In step 604, the first number of transmissions is compared with the second number of transmissions, and the number of transmissions of the PRACH is determined as the larger value or the smaller value between the first number of transmissions and the second number of transmissions.

In the embodiment of the present application, the terminal device may compare the first number of transmissions with the second number of transmissions, and select the larger value between them as the number of transmissions of the PRACH. Of course, based on different application scenarios, the smaller value between the first number of transmissions and the second number of transmissions may also be used as the number of transmissions of the PRACH.

In some implementations, the terminal device determines the number of transmissions of the PRACH according to the first information field, and the random access initiated based on the number of transmissions fails, then the terminal device needs to initiate PRACH retransmission. The terminal device may select at least one of the following manners.

The terminal may choose to determine the number of retransmissions of the PRACH according to the comparison between the measured value of the reference signal and the at least one preset threshold.

The terminal device may also choose to perform PRACH retransmission still based on the number of transmissions indicated by the first information field, that is, determine the number of retransmissions of the PRACH to be the number of transmissions indicated by the first information field.

The terminal device may also choose to wait for receiving first indication information sent by the network device before performing PRACH retransmission, where the first indication information is used to indicate the number of retransmissions of the PRACH, or the first indication information is used to instruct the terminal device to determine the number of retransmissions of the PRACH by itself (for example, determined based on the comparison between the measured value of the reference signal and the at least one preset threshold, or determined based on the number of transmissions indicated by the first information field, etc.).

Optionally, the failure of the random access initiated refers to a failure to receive a second random access message (Msg2).

In various embodiments of the present application, the terminal device determining the number of transmissions of the PRACH by comparing the measured value of the reference signal with at least one preset threshold may specifically include: measuring the reference signal receiving power (RSRP) of the reference signal sent by the network device, comparing the RSRP with the at least one preset threshold, and determining the number of transmissions of the PRACH.

Optionally, the reference signal may be a secondary synchronization signal (SSS), a synchronization signal and physical broadcast channel block (SSB), or other reference signals, etc., which is not limited in the present application.

In various embodiments of the present application, the DCI is further used to instruct the terminal device to initiate a contention-based random access (CBRA), or the DCI is used to instruct the terminal device to initiate a non-contention-based random access (CFRA).

In summary, the downlink control information (DCI) sent by the network device, the first number of transmissions indicated by the first information field in the DCI is determined, the second number of transmissions determined according to the comparison between the measured value of the reference signal and the at least one preset threshold is determined, the first number of transmissions is compared with the second number of transmissions, and the number of transmissions of the PRACH is determined as the larger value between the first number of transmissions and the second number of transmissions. In this way, the terminal device can determine a more reasonable number of transmissions of the physical random access channel (PRACH) in one random access attempt, and reasonably enhance the coverage of PRACH, thereby effectively ensuring the fairness of access opportunities, saving power consumption of the terminal device, and improving the communication efficiency of the system.

Reference is made to FIG. 7, which is a schematic flow chart of a random access method provided in an embodiment of the present application. It should be noted that the random access method in the embodiment of the present application is performed by a network device. The method may be executed independently or in combination with any other embodiment of the present application. As shown in FIG. 7, the method may include the following steps.

In step 701, downlink control information (DCI) is sent to a terminal device, where the DCI is used to indicate the number of transmissions of a physical random access channel (PRACH) of a terminal device.

In the embodiment of the present application, the network device may send downlink control information (DCI) to the terminal device, and the DCI is used by the terminal device to determine the number of transmissions of the physical random access channel (PRACH). The terminal device may determine the number of transmissions of the PRACH based on the received DCI.

In the embodiment of the present application, the DCI is used to indicate the number of transmissions of the PRACH, or the DCI is used to instruct the terminal device to determine the number of transmissions of the PRACH based on a comparison between a measured value of a reference signal and at least one preset threshold. In a possible implementation, the DCI may explicitly or implicitly indicate the number of transmissions of the PRACH.

Implicit indication means that the number of PRACH transmissions is indicated through the format or other parameters of the DCI, where different formats or parameters of the DCI may correspond to different numbers of transmissions of the PRACH.

Explicit indication means that the DCI has a field for indication. For example, in the embodiments of the present application, the DCI includes a first information field, the first information field is used to indicate the number of transmissions of the PRACH, and/or, the first information field is used to indicate that the terminal device determines the number of transmissions of the PRACH according to a comparison between a measured value of a reference signal and at least one preset threshold.

As a possible implementation, the terminal device may determine the number of transmissions of the PRACH according to the indication of the first information field.

As another possible implementation, the terminal device may determine the number of transmissions of the PRACH by comparing the measured value of the reference signal with at least one preset threshold according to the received DCI.

As another possible implementation, the terminal device may compare the number of transmissions determined according to the indication of the first information field with the number of transmissions determined by comparing the measured value of the reference signal with at least one preset threshold, and determine the number of transmissions of the PRACH according to the comparison result of the transmission numbers determined by the two manners.

Optionally, the at least one preset threshold, and the number of transmissions of the PRACH corresponding to each preset threshold, may be determined according to a provision of a protocol, or may be determined according to a configuration or indication of a network device.

In the embodiment of the present application, the first information field may occupy the reserved bits in the DCI, or may multiplex the existing information fields in the DCI.

In some implementations, the terminal device may determine a set of candidate values for the number of transmissions according to a provision of the protocol or the configuration of the network device, and the first information field is used to indicate an index of a candidate value in the set of candidate values.

Optionally, the network device may configure the set of candidate values through Radio Resource Control (RRC) signaling.

Optionally, the set of candidate values may include at least one candidate value of the number of PRACH transmissions.

Optionally, the bit width of the first information field, that is, the number of bits occupied by the first information field, is determined according to the number of candidate values in the set of candidate values.

Optionally, the set of candidate values may include a first value. If the first information field is used to indicate an index corresponding to the first value, the first information field is used to instruct the terminal device to determine the number of transmissions according to the comparison between the measured value of the reference signal and at least one preset threshold.

Optionally, the first value is a null value, such as null or none.

Optionally, if each of at least one bit in the first information field is 0, or the first information field is a multiplexed information field and the value of the first information field remains an original value of the multiplexed information field, the first information field is used to indicate that the PRACH is transmitted once.

Optionally, if at least one bit in the first information field is all 0, or the first information field is a multiplexed information field and the value of the first information field remains an original value of the multiplexed information field, the first information field is used to indicate a candidate value corresponding to the smallest index in the set of candidate values.

In some implementations, if each of at least one bit in the first information field is 0, or the first information field is a multiplexed information field and the value of the first information field remains an original value of the multiplexed information field, the first information field is used to instruct the terminal device to determine the number of transmissions based on the comparison between the measured value of the reference signal and the at least one preset threshold.

In some implementations, the value of a codepoint of the first information field is used to determine the number of transmissions of the PRACH.

Optionally, the maximum value of the value of the codepoint corresponding to the first information field is greater than or equal to the maximum number of PRACH transmissions supported by the terminal device.

In some implementations, the terminal device may determine the number of transmissions of the PRACH by comparing the number of transmissions determined according to the indication of the first information field with the number of transmissions determined by comparing the measured value of the reference signal with the at least one preset threshold.

Specifically, the terminal device may determine a first number of transmissions indicated by the first information field of the DCI, and the terminal device may also determine a second number of transmissions determined according to comparison between the measured value of the reference signal and the at least one preset threshold. The terminal device may compare the first number of transmissions with the second number of transmissions, and determine that the number of transmissions of the PRACH is the larger value between the first number of transmissions and the second number of transmissions.

In some implementations, the terminal device determines the number of transmissions of the PRACH according to the first information field, and the random access initiated based on the number of transmissions fails, then the terminal device needs to initiate PRACH retransmission. The network device may further send first indication information to the terminal device before the terminal device performs PRACH retransmission, and the first indication information is used to indicate the number of retransmissions of the PRACH, or the first indication information is used to instruct the terminal device to determine the number of retransmissions of the PRACH by itself (for example, determined based on the comparison between the measured value of the reference signal and the at least one preset threshold, or determined based on the number of transmissions indicated by the first information field, etc.).

Optionally, the failure of the random access initiated refers to a failure to receive a second random access message (Msg2).

In various embodiments of the present application, the DCI is further used to instruct the terminal device to initiate a contention-based random access (CBRA), or the DCI is used to instruct the terminal device to initiate a non-contention-based random access (CFRA).

In various embodiments of the present application, the terminal device may also receive an RRC reconfiguration signaling sent by the network device to reconfigure the number of PRACH transmissions of the terminal device and/or the at least one preset threshold. If the terminal device does not receive the reconfigured number of PRACH transmissions and/or the at least one preset threshold in the RRC reconfiguration signaling, the terminal device may configure the number of PRACH transmissions and/or the at least one preset threshold according to the configuration parameters of the system information block, such as the RACHConfigCommon in SIB 1.

It can be understood that, in the embodiments of the present application, it is mainly considered that in the case that the network device is able to obtain a relatively accurate uplink condition, the number of transmissions of the PRACH of the terminal device is indicated through the DCI. For example, in the case that the network device may still obtain a relatively accurate uplink condition when the invalidation time of the timing advance (TA) is relatively short (such as the random access channel (RACH) case of uplink out-of-sync and the need to obtain downlink synchronization), or when the network-side scheduling entities of the primary cell (Pcell) and the secondary cell (Scell) are at the same physical node or in the same geographical location (for the random access channel case of obtaining uplink synchronization on the Scell), the number of PRACH transmissions may be determined by the network device and indicated to the terminal. If the network device is not able to obtain an accurate uplink coverage condition, such as in the case of a long period of uplink out-of-sync, or the Pcell and Scell being located in different geographical locations, the terminal device may determine the number of transmissions of the PRACH in one random access attempt by itself through measuring the reference signal.

In a possible implementation, the DCI is used to instruct the terminal device to determine the number of PRACH transmissions from the candidate values in the set of candidate values. As described above, the number of transmissions of the PRACH may be indicated implicitly or explicitly through the DCI. Implicit indication means indicating the number of transmissions of the PRACH through the correspondence between the formats or other parameters of the DCI and the candidate values in the set of candidate values, where different formats or parameters of the DCI may correspond to different numbers of transmissions of the PRACH. Explicit indication means that the DCI has a field for indication. For example, the DCI includes a first information field, and the first information field is used to indicate the index corresponding to the candidate value in the set of candidate values.

In a possible implementation, the DCI includes a first information field, and a value of a codepoint corresponding to the first information field is used to indicate the number of PRACH transmissions.

In another possible implementation, the DCI includes a first information field, which is used to instruct the terminal device to determine the number of PRACH transmissions according to a comparison between a measured value of a reference signal and at least one preset threshold. The specific determination manner may refer to other embodiments of the present disclosure, and the same content will not be repeated herein.

In yet another possible implementation, the DCI is used to instruct the terminal device to determine the first number of transmissions corresponding to the DCI and the second number of transmissions determined according to the comparison between the measured value of the reference signal and at least one preset threshold; the first number of transmissions is compared with the second number of transmissions, and the number of transmissions of the PRACH is determined as either the larger value or the smaller value between the first number of transmissions and the second number of transmissions. The specific determination manner may refer to other embodiments of the present disclosure, and the same content will not be repeated herein.

In summary, the downlink control information (DCI) is sent to the terminal device, and the DCI is used by the terminal device to determine the number of transmissions of the physical random access channel (PRACH), so that the terminal device can determine a more reasonable number of transmissions of the physical random access channel (PRACH) in one random access attempt, and reasonably enhance the coverage of PRACH, thereby effectively ensuring the fairness of access opportunities, saving power consumption of the terminal device, and improving the communication efficiency of the system.

Corresponding to the random access methods provided by the above-mentioned embodiments, the present application further provides a random access apparatus. Since the random access apparatus provided by the embodiments of the present application corresponds to the methods provided in the above several embodiments, the implementations of the random access methods are also applicable to the random access apparatus provided in the following embodiments, and will not be described in detail in the following embodiments.

Reference is made to FIG. 8, which is a schematic structural diagram of a random access apparatus provided in an embodiment of the present application.

As shown in FIG. 8, the random access apparatus 800 includes: a transceiver unit 810 and a processing unit 820.

The transceiver unit 810 is configured to receive downlink control information (DCI) sent by a network device;

The processing unit 820 is configured to determine the number of transmissions of a physical random access channel (PRACH) according to the DCI.

Optionally, the DCI includes a first information field, and the first information field is used to indicate the number of transmissions; or, the DCI is used to instruct the terminal device to determine the number of transmissions according to a comparison between a measured value of a reference signal and at least one preset threshold.

Optionally, the processing unit 820 is further configured to determine a set of candidate values of the number of transmissions according to a provision of a protocol or a configuration of the network device; where the first information field is used to indicate an index of a value in the set of candidate values.

Optionally, a bit width of the first information field is determined according to the number of candidate values in the set of candidate values.

Optionally, in response to each of at least one bit included in the first information field being 0, or, the first information field being a multiplexed information field and a value of the first information field remaining an original value of the multiplexed information field, the first information field is used to indicate that the number of transmissions of the PRACH is one.

Optionally, in response to each of at least one bit included in the first information field being 0, or, the first information field being a multiplexed information field and a value of the first information field remaining an original value of the multiplexed information field, the first information field is used to indicate that the number of transmissions of the PRACH is a candidate value corresponding to a smallest index in the set of candidate values.

Optionally, the set of candidate values includes a first numerical value; in response to the first information field being used to indicate an index corresponding to the first numerical value, the first information field is used to instruct the terminal device to determine the number of transmissions according to the comparison between the measured value of the reference signal and the at least one preset threshold.

Optionally, the first numerical value is a null value.

Optionally, in response to each of at least one bit included in the first information field being 0, or, the first information field being a multiplexed information field and a value of the first information field remaining an original value of the multiplexed information field, the first information field is used to instruct the terminal device to determine the number of transmissions according to the comparison between the measured value of the reference signal and the at least one preset threshold.

Optionally, a value of a codepoint of the first information field is used to indicate the number of transmissions.

Optionally, a maximum value of the value of the codepoint corresponding to the first information field is greater than or equal to a maximum number of transmissions of the PRACH supported by the terminal device.

Optionally, the processing unit 820 is further configured to determine a first number of transmissions indicated by the first information field; determine a second number of transmissions determined according to the comparison between the measured value of the reference signal and the at least one preset threshold; compare the first number of transmissions with the second number of transmissions, and determine the number of transmissions of the PRACH as the larger value between the first number of transmissions and the second number of transmissions.

Optionally, in response to the first information field being used to indicate the number of transmissions, and the random access initiated based on the number of transmissions failing, the processing unit 820 is further configured to perform at least one of the following: determining the number of retransmissions of the PRACH according to the comparison between the measured value of the reference signal and the at least one preset threshold; determining the number of retransmissions of the PRACH to be the number of transmissions indicated by the first information field; and receiving first indication information sent by the network device, where the first indication information is used to indicate the number of retransmissions of the PRACH, or the first indication information is used to instruct the terminal device to determine the number of retransmissions of the PRACH.

Optionally, the failure of the random access initiated is a failure to receive a second random access message (Msg2).

Optionally, in response to the first information field being used to instruct the terminal device to determine the number of transmissions according to the comparison between the measured value of the reference signal and the at least one preset threshold, the processing unit 820 is further configured to: measure a reference signal received power (RSRP) of the reference signal sent by the network device; and compare the RSRP with the at least one preset threshold to determine the number of transmissions of the PRACH.

Optionally, the at least one preset threshold and the number of transmissions corresponding to each preset threshold is determined according to a provision of a protocol or a configuration/instruction of the network device.

Optionally, the method further includes: initiating a contention-based random access according to the DCI; or, initiating a non-contention-based random access according to the DCI.

The random access apparatus of the present embodiment may receive the downlink control information (DCI) sent by the network device, and determine the number of transmissions of the physical random access channel (PRACH) according to the DCI, so that the terminal device can determine a more reasonable number of transmissions of the physical random access channel (PRACH) in one random access attempt, and reasonably enhance the coverage of PRACH, thereby effectively ensuring the fairness of access opportunities, saving power consumption of the terminal device, and improving the communication efficiency of the system.

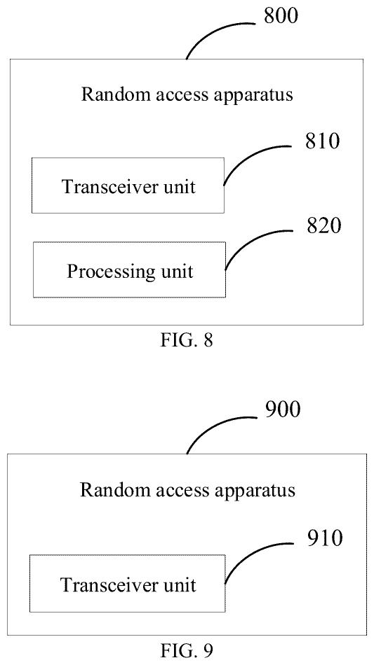

Reference is made to FIG. 9, which is a schematic structural diagram of a random access apparatus provided by an embodiment of the present application.

As shown in FIG. 9, the random access apparatus 900 includes a transceiver unit 910.

The transceiver unit 910 is configured to send downlink control information (DCI) to a terminal device; where the DCI is used to indicate the number of transmissions of a physical random access channel (PRACH) of the terminal device.

Optionally, the DCI includes a first information field, and the first information field is used to indicate the number of transmissions; or, the DCI is used to instruct the terminal device to determine the number of transmissions according to a comparison between a measured value of a reference signal and at least one preset threshold.

Optionally, the transceiver unit 910 is further configured to send configuration information to the terminal device, where the configuration information is used to configure a set of candidate values of the number of transmissions; and the first information field is used to indicate an index of a value in the set of candidate values.

Optionally, a bit width of the first information field is determined according to the number of candidate values in the set of candidate values.

Optionally, in response to each of at least one bit included in the first information field being 0, or, the first information field being a multiplexed information field and a value of the first information field remaining an original value of the multiplexed information field, the first information field is used to indicate that the number of transmissions of the PRACH is one.

Optionally, in response to each of at least one bit included in the first information field being 0, or, the first information field being a multiplexed information field and a value of the first information field remaining an original value of the multiplexed information field, the first information field is used to indicate that the number of transmissions of the PRACH is a candidate value corresponding to a smallest index in the set of candidate values.

Optionally, the set of candidate values includes a first numerical value; in response to the first information field being used to indicate an index corresponding to the first numerical value, the first information field is used to instruct the terminal device to determine the number of transmissions according to the comparison between the measured value of the reference signal and the at least one preset threshold.

Optionally, the first numerical value is a null value.

Optionally, in response to each of at least one bit included in the first information field being 0, or, the first information field being a multiplexed information field and a value of the first information field remaining an original value of the multiplexed information field, the first information field is used to instruct the terminal device to determine the number of transmissions according to the comparison between the measured value of the reference signal and the at least one preset threshold.

Optionally, a value of a codepoint of the first information field is used to indicate the number of transmissions.

Optionally, a maximum value of the value of the codepoint corresponding to the first information field is greater than or equal to a maximum number of transmissions of the PRACH supported by the terminal device.

Optionally, in response to the first information field being used to indicate the number of transmissions, and the random access initiated based on the number of transmissions failing, the transceiver unit 910 is further configured to send first indication information to the terminal device, where the first indication information is used to indicate the number of retransmissions of the PRACH, or the first indication information is used to instruct the terminal device to determine the number of retransmissions of the PRACH.

Optionally, the failure of the random access initiated is a failure to receive a second random access message (Msg2).

Optionally, the DCI is further used to initiate a contention-based random access; or, the DCI is further used to initiate a non-contention-based random access.

The random access apparatus of the present embodiment may send the downlink control information (DCI) to the terminal device, and the DCI is used by the terminal device to determine the number of transmissions of the physical random access channel (PRACH), so that the terminal device can determine a more reasonable number of transmissions of the physical random access channel (PRACH) in one random access attempt, and reasonably enhance the coverage of PRACH, thereby effectively ensuring the fairness of access opportunities, saving power consumption of the terminal device, and improving the communication efficiency of the system.

In order to implement the above embodiments, an embodiment of the present application further proposes a communication apparatus, including: a processor and a memory, where the memory stores a computer program, and the processor executes the computer program stored in the memory to cause the apparatus to execute the method shown in the embodiments of FIGS. 2 to 6.

In order to implement the above embodiments, an embodiment of the present application further proposes a communication apparatus, including: a processor and a memory, where the memory stores a computer program, and the processor executes the computer program stored in the memory to cause the apparatus to execute the method shown in the embodiment of FIG. 7.

In order to implement the above embodiments, an embodiment of the present application further proposes a communication apparatus, including: a processor and an interface circuit, where the interface circuit is configured to receive code instructions and transmit them to the processor, and the processor is configured to run the code instructions to execute the method shown in the embodiments of FIGS. 2 to 6.

In order to implement the above embodiments, an embodiment of the present application further proposes a communication apparatus, including: a processor and an interface circuit, where the interface circuit is configured to receive code instructions and transmit them to the processor, and the processor is configured to run the code instructions to execute the method shown in the embodiment of FIG. 7.

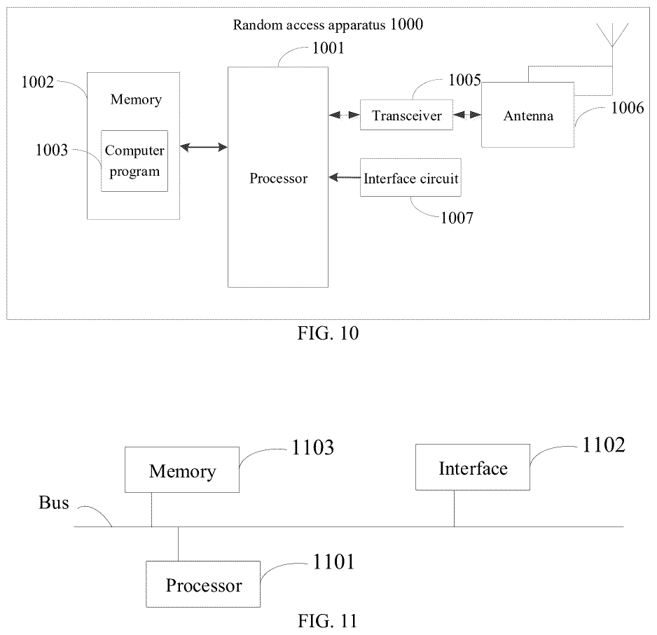

Reference is made to FIG. 10, which is a schematic structural diagram of another random access apparatus provided by an embodiment of the present application. The random access apparatus 1000 may be a network device, or a terminal device, or a chip, a chip system, or a processor that supports the network device to implement the above method, or a chip, a chip system, or a processor that supports the terminal device to implement the above method. The apparatus may be used to implement the methods described in the above method embodiments, and the details can be referred to in the description in the above method embodiments.

The random access apparatus 1000 may include one or more processors 1001. The processor 1001 may be a general-purpose processor or a special-purpose processor, etc. For example, it may be a baseband processor or a central processing unit. The baseband processor may be configured to process a communication protocol as well as communication data, and the central processing unit may be configured to control the random access apparatus (e.g., a base station, a baseband chip, a terminal device, a terminal device chip, a DU or a CU, etc.), execute a computer program, and process data of the computer program.

Optionally, the random access apparatus 1000 may further include one or more memories 1002, on which a computer program 1003 may be stored, and the processor 1001 executes the computer program 1003, so that the random access apparatus 1000 performs the methods described in the above method embodiments. The computer program 1003 may be solidified in the processor 1001, in which case the processor 1001 may be implemented by hardware.

Optionally, data may also be stored in the memory 1002. The random access apparatus 1000 and the memory 1002 may be provided separately or integrated together.

Optionally, the random access apparatus 1000 may further include a transceiver 1005 and an antenna 1006. The transceiver 1005 may be referred to as a transceiving unit, a transceiver, or a transceiver circuit, etc., which is used to implement the transceiving function. The transceiver 1005 may include a receiver and a transmitter, the receiver may be referred to as a receiver or a receiving circuit, etc., which is used to implement the receiving function; the transmitter may be referred to as a transmitter or a transmitting circuit, etc., which is used to implement the transmitting function.

Optionally, the random access apparatus 1000 may further include one or more interface circuits 1007. The interface circuit 1007 is used to receive code instructions and transmit them to the processor 1001. The processor 1001 executes the code instructions to enable the random access apparatus 1000 to perform the methods described in the above method embodiments.

In an implementation, the processor 1001 may include a transceiver for implementing the receiving and transmitting functions. The transceiver may be, for example, a transceiver circuit, an interface, or an interface circuit. The transceiver circuit, interface, or interface circuit for implementing the receiving and transmitting functions may be separated or may be integrated together. The transceiver circuit, interface, or interface circuit described above may be used for code/data reading and writing, or may be used for signal transmission or delivery.

In an implementation, the random access apparatus 1000 may include circuits. The circuits may implement the sending, receiving or communicating function in the preceding method embodiments. The processor and transceiver described in the present application may be implemented on integrated circuits (ICs), analog ICs, radio frequency integrated circuits (RFICs), mixed signal ICs, application specific integrated circuits (ASICs), printed circuit boards (PCBs), and electronic devices. The processor and transceiver may also be produced using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The random access apparatus described in the above embodiments may be a network device or a terminal device, but the scope of the random access apparatus described in the present application is not limited thereto, and the structure of the random access apparatus may not be limited by FIG. 13-FIG. 14. The random access apparatus may be an independent device or may be part of a larger device. For example, the random access apparatus may be:
(1) a stand-alone IC, chip, chip system or subsystem;
(2) a collection of ICs including one or more ICs, optionally, the collection of ICs may also include storage components for storing data and computer programs;
(3) an ASIC, such as a modem;
(4) modules that may be embedded within other devices;
(5) receivers, terminals, smart terminals, cellular phones, wireless devices, handheld machines, mobile units, in-vehicle devices, network devices, cloud devices, artificial intelligence devices, and the like; and
(6) others.

For the case where the random access apparatus may be a chip or a chip system, with reference to the structural diagram of the chip shown in FIG. 11. The chip shown in FIG. 11 includes a processor 1101 and an interface 1102. There may be one or more processors 1101, and there may be a plurality of the interfaces 1102.

For the case where the chip is used to implement the functions of the terminal device in the embodiments of the present application:
the interface 1102 is configured to receive code instructions and transmit the code instructions to the processor; and
the processor 1101 is configured to run code instructions to execute the method shown in FIGS. 2 to 6.

For the case where the chip is used to implement the functions of the network device in the embodiments of the present application:
the interface 1102 is configured to receive code instructions and transmit the code instructions to the processor; and
the processor 1101 is configured to run code instructions to execute the method shown in FIG. 7.

Optionally, the chip further includes a memory 1103, and the memory 1103 is configured to store necessary computer programs and data.

It is understandable by those skilled in the art that various illustrative logical blocks and steps listed in the embodiments of the present application may be implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be construed as being beyond the scope of protection of the embodiments of the present application.

An embodiment of the present application further provides a communication system, which includes the random access apparatus as a terminal device and the random access apparatus as a network device in the above embodiments of FIGS. 8 and 9, or the system includes the random access apparatus as a terminal device and the random access apparatus as a network device in the above embodiment of FIG. 10.

The present application further provides a readable storage medium having instructions stored thereon. When the instructions are executed by a computer, the function of any of the method embodiments described above is implemented.

The present application further provides a computer program product. When the computer program product is executed by a computer, the function of any of the method embodiments described above is implemented.

The above embodiments may be implemented in whole or in part by software, hardware, firmware, or any combination thereof. When implemented using software, it may be implemented, in whole or in part, in the form of a computer program product. The computer program product includes one or more computer programs. When loading and executing the computer program on the computer, all or part of the processes or functions described in the embodiments of the present application is implemented. The computer may be a general-purpose computer, a dedicated computer, a computer network, or other programmable devices. The computer program may be stored in a computer-readable storage medium or transmitted from one computer-readable storage medium to another computer-readable storage medium. For example, the computer program may be transmitted from one web site, computer, server, or data center to another web site, computer, server, or data center, in a wired manner (e.g., by using coaxial cables, fiber optics, or digital subscriber lines (DSLs) or wirelessly (e.g., by using infrared wave, wireless wave, or microwave). The computer-readable storage medium may be any usable medium to which the computer has access or a data storage device integrated by one or more usable mediums such as a server and a data center. The usable medium may be a magnetic medium (e.g., floppy disk, hard disk, and tape), an optical medium (e.g., a high-density digital video disc (DVD)), or a semiconductor medium (e.g., a solid state disk (SSD)), etc.

Those skilled in the art understand that “first”, “second”, and other various numerical numbers involved in the present application are only described for the convenience of differentiation, and are not used to limit the scope of the embodiments of the present application, or indicate the order of precedence.

The term “at least one” in the present application may also be described as one or more, and the term “multiple” may be two, three, four, or more, which is not limited by the present application. In the embodiments of the present application, for a type of technical features, “first”, “second”, and “third”, and “A”, “B”, “C” and “D” are used to distinguish different technical features of the type, the technical features described using the “first”, “second”, and “third”, and “A”, “B”, “C” and “D” do not indicate any order of precedence or magnitude.

The correspondence shown in the tables in the present application may be configured or may be predefined. The values of information in the tables are merely examples and may be configured to other values, which are not limited by the present application. In configuring the correspondence between the information and the parameter, it is not necessarily required that all the correspondences illustrated in the tables must be configured. For example, the correspondences illustrated in certain rows in the tables in the present application may not be configured. For another example, the above tables may be adjusted appropriately, such as splitting, combining, and the like. The names of the parameters shown in the titles of the above tables may be other names that may be understood by the communication apparatus, and the values or representations of the parameters may be other values or representations that may be understood by the communication apparatus. Each of the above tables may also be implemented with other data structures, such as, arrays, queues, containers, stacks, linear tables, pointers, chained lists, trees, graphs, structures, classes, heaps, and Hash tables.

The term “predefine” in the present application may be understood as define, define in advance, store, pre-store, pre-negotiate, pre-configure, solidify, or pre-bake.

Those skilled in the art may realize that the units and algorithmic steps of the various examples described in combination with the embodiments disclosed herein are capable of being implemented in the form of electronic hardware, or a combination of computer software and electronic hardware. Whether these functions are performed in the form of hardware or software depends on the specific application and design constraints of the technical solution. Those skilled in the art may use different methods to implement the described functions for each particular application, but such implementations should not be considered as beyond the scope of the present application.

It is clearly understood by those skilled in the field to which it belongs that, for the convenience and brevity of description, the specific working processes of the systems, apparatuses, and units described above may be referred to the corresponding processes in the preceding method embodiments, and will not be repeated herein.

It should be understood that various forms of processes shown above can be used, and steps can be reordered, added, or deleted. For example, the steps described in the embodiments of the present application can be executed in parallel, sequentially, or in a different order. As long as the desired results of the technical solutions disclosed in the present disclosure can be achieved, no limitations are imposed herein.

The above specific implementations do not constitute a limitation on the protection scope of the present disclosure. It should be understood by those skilled in the art that various modifications, combinations, sub-combinations and substitutions can be made according to design requirements and other factors. Any modification, equivalent substitution and improvement made within the spirit and principle of the present disclosure should be included in the protection scope of the present disclosure.

1. A random access method, performed by a terminal device, comprising:
receiving downlink control information (DCI) sent by a network device; and
determining the number of transmissions of a physical random access channel (PRACH) according to the DCI.

2. The method according to claim 1, wherein the DCI comprises a first information field, and the first information field is used to indicate the number of transmissions; or, the first information field is used to instruct the terminal device to determine the number of transmissions according to a comparison between a measured value of a reference signal and at least one preset threshold.

3. The method according to claim 2, further comprising:
determining a set of candidate values of the number of transmissions wherein the first information field is used to indicate an index of a value in the set of candidate values.

4. (canceled)

5. The method according to claim 3, wherein each of at least one bit comprised in the first information field is 0, or, the first information field is a multiplexed information field and a value of the first information field remains an original value of the multiplexed information field,
the first information field is used to indicate that the number of transmissions of the PRACH is one or indicate that the number of transmissions of the PRACH is a candidate value corresponding to a smallest index in the set of candidate values.

6. (canceled)

7. The method according to claim 3, wherein the set of candidate values comprises a first numerical value; and
the first information field is used to indicate an index corresponding to the first numerical value, the first information field is used to instruct the terminal device to determine the number of transmissions according to the comparison between the measured value of the reference signal and the at least one preset threshold.

8. (canceled)

9. The method according to claim 2, wherein each of at least one bit comprised in the first information field is 0, or, the first information field is a multiplexed information field and a value of the first information field remains an original value of the multiplexed information field, the first information field is used to instruct the terminal device to determine the number of transmissions according to the comparison between the measured value of the reference signal and the at least one preset threshold.

10. The method according to claim 2, wherein a value of a codepoint of the first information field is used to indicate the number of transmissions, and a maximum value of the value of the codepoint corresponding to the first information field is greater than or equal to a maximum number of transmissions of the PRACH supported by the terminal device.

11. (canceled)

12. The method according to claim 2, further comprising:
determining a first number of transmissions indicated by the first information field;
determining a second number of transmissions determined according to the comparison between the measured value of the reference signal and the at least one preset threshold; and
comparing the first number of transmissions with the second number of transmissions, and determining that the number of transmissions of the PRACH is a greater value of the first number of transmissions and the second number of transmissions.

13. The method according to claim 2, wherein the first information field is used to indicate the number of transmissions and a failure of a random access initiated based on the number of transmissions, the method further comprises at least one of following:
determining the number of retransmissions of the PRACH according to the comparison between the measured value of the reference signal and the at least one preset threshold;
determining the number of retransmissions of the PRACH to be the number of transmissions indicated by the first information field; or
receiving first indication information sent by the network device, wherein the first indication information is used to indicate the number of retransmissions of the PRACH, or the first indication information is used to instruct the terminal device to determine the number of retransmissions of the PRACH.

14. The method according to claim 13, wherein the failure of the random access initiated is a failure to receive a second random access message (Msg2).

15. The method according to claim 2, wherein the first information field is used to instruct the terminal device to determine the number of transmissions according to the comparison between the measured value of the reference signal and the at least one preset threshold, the method further comprises:
measuring a reference signal received power (RSRP) of the reference signal sent by the network device; and
determining the number of transmissions of the PRACH by comparing the RSRP with the at least one preset threshold.

16. (canceled)

17. (canceled)

18. A random access method, performed by a network device, comprising:
sending downlink control information (DCI) to a terminal device; wherein the DCI is used to indicate the number of transmissions of a physical random access channel (PRACH) of the terminal device.

19. The method according to claim 18, wherein the DCI comprises a first information field, and the first information field is used to indicate the number of transmissions; or, the first information field is used to instruct the terminal device to determine the number of transmissions according to a comparison between a measured value of a reference signal and at least one preset threshold.

20. The method according to claim 19, further comprising:
sending configuration information to the terminal device, wherein the configuration information is used to configure a set of candidate values of the number of transmissions, and the first information field is used to indicate an index of a value in the set of candidate values.

21. (canceled)

22. The method according to claim 20, wherein each of at least one bit comprised in the first information field is 0, or, the first information field is a multiplexed information field and a value of the first information field remains an original value of the multiplexed information field, the first information field is used to indicate that the number of transmissions of the PRACH is one or indicate that the number of transmissions of the PRACH is a candidate value corresponding to a smallest index in the set of candidate values.

23. (canceled)

24. The method according to claim 20, wherein the set of candidate values comprises a first numerical value; and
the first information field is used to indicate an index corresponding to the first numerical value, the first information field is used to instruct the terminal device to determine the number of transmissions according to the comparison between the measured value of the reference signal and the at least one preset threshold.

25. (canceled)

26. The method according to claim 19, wherein each of at least one bit comprised in the first information field is 0, or, the first information field is a multiplexed information field and a value of the first information field remains an original value of the multiplexed information field, the first information field is used to instruct the terminal device to determine the number of transmissions according to the comparison between the measured value of the reference signal and the at least one preset threshold.

27. The method according to claim 19, wherein a value of a codepoint of the first information field is used to indicate the number of transmissions, and a maximum value of the value of the codepoint corresponding to the first information field is greater than or equal to a maximum number of transmissions of the PRACH supported by the terminal device.

28. (canceled)

29. The method according to claim 19, wherein the first information field is used to indicate the number of transmissions and a failure of a random access initiated based on the number of transmissions, the method further comprises:
sending first indication information to the terminal device, wherein the first indication information is used to indicate the number of retransmissions of the PRACH, or the first indication information is used to instruct the terminal device to determine the number of retransmissions of the PRACH.

30.-33. (canceled)

34. A communication apparatus, comprising a processor and a memory, wherein the memory stores a computer program, and the processor executes the computer program stored in the memory to cause the apparatus to:
receive downlink control information (DCI) sent by a network device; and
determine the number of transmissions of a physical random access channel (PRACH) according to the DCI.

35. (canceled)

36. (canceled)
